(19) United States
(12) Patent Application Publication
(10) Pub. No.: US 2009/0070109 A1
(43) Pub. Date: Mar. 12, 2009

(54) Speech-to-Text Transcription for Personal Communication Devices

(75) Inventors: Clifford Neil Didcock, Sammamish, WA (US); Thomas W. Millett, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/854,523

(22) Filed: Sep. 12, 2007

(51) Int. Cl. G10L 15/26

(52) U.S. Cl. 704/235; 704/E15.043

(57) ABSTRACT

A speech-to-text transcription system for a personal communication device (PCD) is housed in a communications server that is communicatively coupled to one or more PCDs. A user of the PCD, dictates an e-mail, for example, into the PCD. The PCD converts the user's voice into a speech signal that is transmitted to the speech-to-text transcription system located in the server. The speech-to-text transcription system transcribes the speech signal into a text message. The text message is then transmitted by the server to the PCD. Upon receiving the text message, the user carries out corrections on erroneously transcribed words before using the text message in various applications.

### TECHNICAL FIELD

The technical field relates generally to personal communication devices and specifically relates to speech-to-text transcription by server resources on behalf of personal communication devices.

### BACKGROUND

Users of personal communication devices such as cellular phones or personal digital assistants (PDAs) are constrained to entering text using keypads and other text entry mechanisms that are limited in size as well as functionality, thereby leading to a large degree of inconvenience as well as inefficiency. For example, the keypad of a cellular phone typically contains several keys that are multifunctional keys. Specifically, a single key is used to enter one of three alphabets, such as A, B, or C. The keypad of a personal digital assistant (PDA) provides some improvement by incorporating a QWERTY keyboard wherein individual keys are used for individual alphabets. Nonetheless, the miniature size of the keys proves to be inconvenient to some users and a severe handicap to others.

As a result of these handicaps, various alternative solutions for entering information into personal communication devices have been introduced. For example, a speech recognition system has been embedded into a cellular phone for enabling input via voice. This approach has provided certain benefits such as for dialing telephone numbers using spoken commands. However, it has failed to satisfy the needs for more complex tasks such as e-mail text entry, due to various factors related to cost and hardware/software limitations in mobile devices.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

In one exemplary method for generating text, a speech signal is created by speaking a portion of an e-mail, for example, into a personal communications device (PCD). The generated speech signal is transmitted to a server. The server houses a speech-to-text transcription system, which transcribes the speech signal into a text message that is returned to the PCD. The text message is edited on the PCD for correcting any transcription errors and then used in various applications. In one exemplary application, the edited text is transmitted in an e-mail format to an e-mail recipient.

In another exemplary method for generating text, a speech signal generated by a PCD is received in a server. The speech signal is transcribed into a text message by using a speech-to-text transcription system located in the server. The text message is then transmitted to the PCD. Additionally, in one further example, the transcription process includes generating a list of alternative candidates for speech recognition of a spoken word. This list of alternative candidates is transmitted together with a transcribed word, by the server to the PCD.

### BRIEF DESCRIPTION OF THE DRAWINGS

The foregoing summary, as well as the following detailed description, is better understood when read in conjunction with the appended drawings. For the purpose of illustrating speech-to-text transcription for personal communication devices, there is shown in the drawings exemplary constructions thereof, however, speech-to-text transcription for personal communication devices is not limited to the specific methods and instrumentalities disclosed.

FIG. 1 shows an exemplary communication system 100 incorporating a speech-to-text transcription system for personal communication devices.

FIG. 2 shows an exemplary sequence of steps for generating text using speech-to-text transcription, the method being implemented on the communication system of FIG. 1.

FIG. 3 is a diagram of an exemplary processor for implementing speech-to-text transcription for personal communication devices.

FIG. 4 is a depiction of a suitable computing environment in which speech-to-text transcription for personal communication devices may be implemented.

### DETAILED DESCRIPTION OF ILLUSTRATIVE EMBODIMENTS

In the various exemplary embodiments described below, a speech-to-text transcription system for personal communication devices is housed in a communications server that is communicatively coupled to one or more mobile devices. Unlike a speech recognition system that is housed in a mobile device, the speech-to-text transcription system located in the server is feature-rich and efficient because of the availability of extensive, cost-effective storage capacity and computing power in the server. A user of the mobile device, which is referred to herein as a personal communications device (PCD), dictates the audio of, for example an e-mail, into the PCD. The PCD converts the user's voice into a speech signal that is transmitted to the speech-to-text transcription system located in the server. The speech-to-text transcription system transcribes the speech signal into a text message by using speech recognition techniques. The text message is then transmitted by the server to the PCD. Upon receiving the text message, the user carries out corrections on erroneously transcribed words before using the text message in various applications that utilize text.

In one exemplary application, the edited text message is used to form, for example, the body part of an e-mail that is then sent to an e-mail recipient. In an alternative application, the edited text message is used in a utility such as Microsoft WORD™. In yet another application, the edited text is inserted into a memo. This and other such examples where text is used will be understood by persons of ordinary skill in the art and, consequently, the scope of this disclosure is intended to encompass all such areas.

The arrangement described above provides several advantages. For example, the speech-to-text transcription system located in the server incorporates a cost effective speech recognition system that provides high word recognition accuracy, typically in the mid-to-high 90% range, in comparison to a more limited speech recognition system housed inside a PCD.

Furthermore, using the keypad of the PCD for editing a few incorrect words in a text message generated by speech-to-text transcription is more efficient and preferable to entering the entire text of an e-mail message by manually depressing keys on the keypad of the PCD. With a good speech-to-text transcription system, the number of incorrect words would typically be fewer than 10% of the total number of words in the transcribed text message.

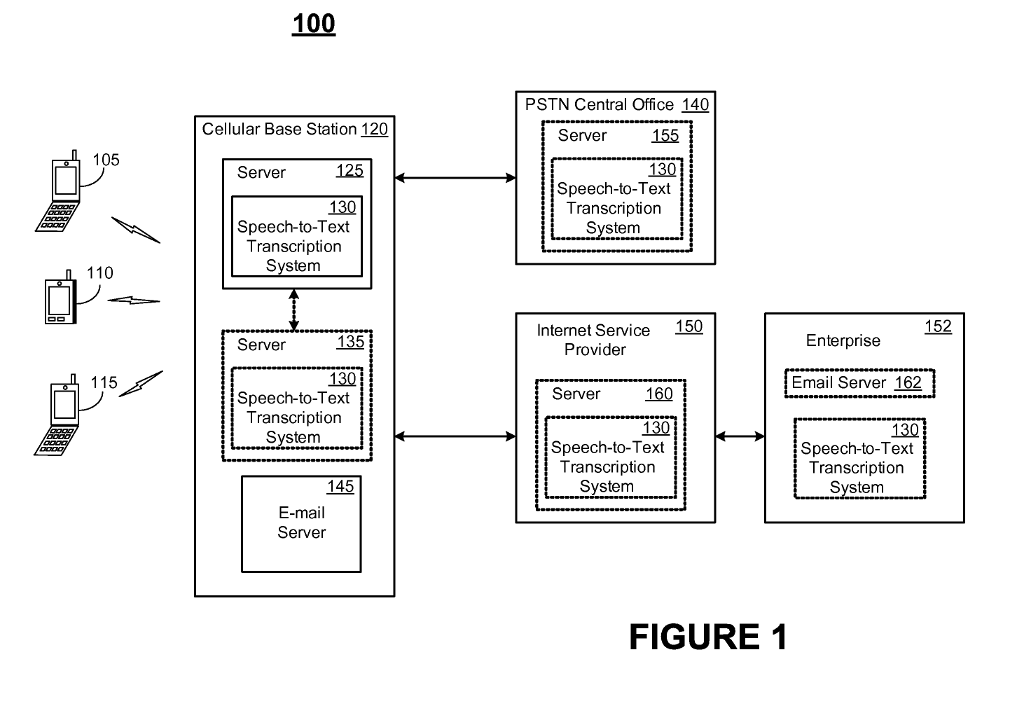

FIG. 1 shows an exemplary communication system 100 incorporating a speech-to-text transcription system 130 housed in a server 125 located in cellular base station 120. Cellular base station 120 provides cellular communication services to various PCDs, as is known in the art. Each of these PCDs is communicatively coupled to server 125, either on an as-needed basis or on a continuous basis, for purposes of accessing speech-to-text transcription system 130.

A few non-exhaustive examples of PCDs include PCD 105, which is a smartphone; PCD 110, which is a personal digital assistant (PDA); and PCD 115, which is a cellular phone having text entry facility. PCD 105, the smartphone, combines a cellular phone with a computer thereby providing voice as well as data communication features including e-mail. PCD 110, the PDA, combines a computer for data communication, a cellular phone for voice communication, and a database for storing personal information such as addresses, appointments, calendar, and memos. PCD 115, the cellular phone, provides voice communication as well as certain text entry facilities such as short message service (SMS).

In one specific exemplary embodiment, in addition to housing speech-to-text transcription system 130, cellular base station 120 further includes an e-mail server 145 that provides e-mail services to the various PCDs. Cellular base station 120 also is communicatively coupled to other network elements such as Public Switched Telephone Network Central Office (PSTN CO) 140 and, optionally, to an Internet Service Provider (ISP) 150. Details of the operation of cellular base station 120, e-mail server 145, ISP 150, and PSTN CO 140 will not be provided herein so as to maintain focus upon the pertinent aspects of the speech-to-text transcription system for PCDs, and avoid any distraction arising from subject matter that is known to persons of ordinary skill in the art. In an example configuration, the ISP 150 is coupled to an enterprise 152 comprising an email server 162 and the speech-to-text transcription system 130 for handling email and transcription functions.

Speech-to-text transcription system 130 may be housed in several alternative locations in communication network 100. For example, in a first exemplary embodiment, speech-to-text transcription system 130 is housed in a secondary server 135 located in cellular base station 120. Secondary server 135 is communicatively coupled to server 125, which operates as a primary server in this configuration. In a second exemplary embodiment, speech-to-text transcription system 130 is housed in a server 155 located in PSTN CO 140. In a third exemplary embodiment, speech-to-text transcription system 130 is housed in a server 160 located in a facility of ISP 150.

Typically, as mentioned above, speech-to-text transcription system 130 includes a speech recognition system. The speech recognition system may be a speaker-independent system or a speaker-dependent system. When speaker-dependent, speech-to-text transcription system 130 includes a training feature where a PCD user is prompted to speak several words, either in the form of individual words or in the form of a specified paragraph. These words are stored as a customized template of words for use by this PCD user. Additionally, speech-to-text transcription system 130 may also incorporate, in the form of one or more databases associated with each individual PCD user, one or more of the following: a customized list of vocabulary words that are preferred and generally spoken by the user, a list of e-mail addresses used by the user, and a contact list having personal information of one or more contacts of the user.

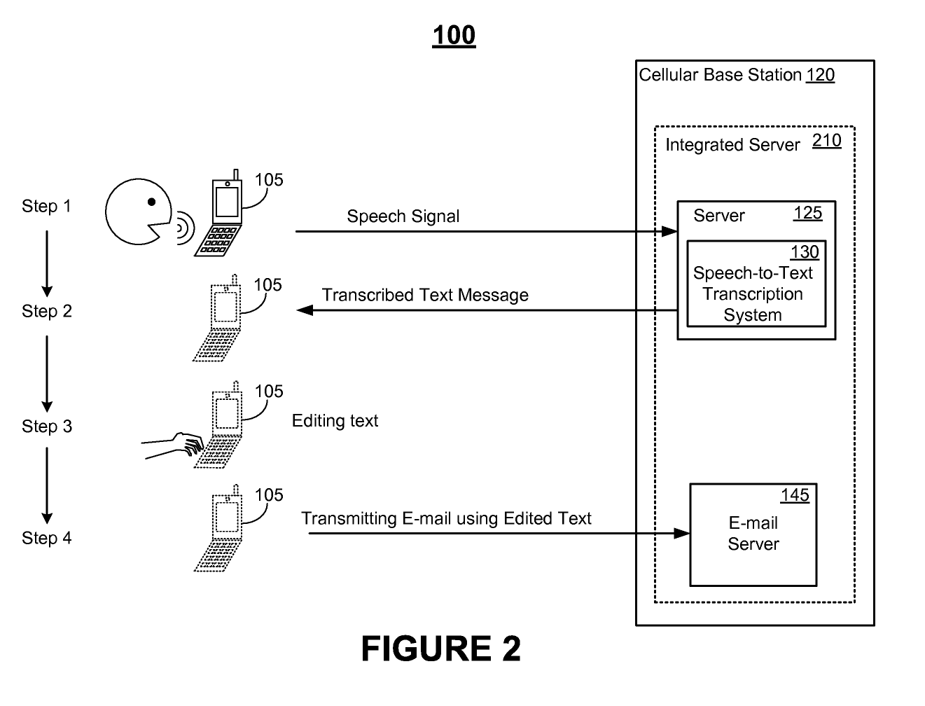

FIG. 2 shows an exemplary sequence of steps for generating text using speech-to-text transcription, the method being implemented on communication system 100. In this particular example, speech-to-text transcription is used for transmitting an e-mail via e-mail server 145. Server 125, which is located in cellular base station 120, contains speech-to-text transcription system 130. Rather than using two separate servers, a single integrated server 210 may be optionally used to incorporate the functionality of server 125 as well as e-mail server 145. Consequently, in such a configuration integrated server 210 carries out operations associated with speech-to-text transcription as well as with e-mail services by using commonly-shared resources.

The sequence of operational steps begins with Step 1 where a PCD user dictates an e-mail into PCD 105. The dictated audio may be one of several alternative materials pertaining to an e-mail. A few non-exhaustive examples of such materials include: a portion of the body of an e-mail, the entire body of an e-mail, a subject line text, and one or more e-mail addresses. The dictated audio is converted into an electronic speech signal in PCD 105, encoded suitably for wireless transmission, and then transmitted to cellular base station 120, where it is routed to speech-to-text transcription system 130.

Speech-to-text transcription system 130, which typically includes a speech recognition system (not shown) and a text generator (not shown), transcribes the speech signal into text data. The text data is encoded suitably for wireless transmission and transmitted, in Step 2, back to PCD 105. Step 2 may be implemented in an automatic process, where the text message is automatically sent to PCD 105 without any action being carried out by a user of PCD 105. In an alternative process, the PCD user has to manually operate PCD 105, by activating certain keys for example, for downloading the text message from speech-to-text transcription system 130 into PCD 105. The text message is not transmitted to PCD 105 until this download request has been made by the PCD user.

In Step 3, the PCD user edits the text message and suitably formats it into an e-mail message. Once the e-mail has been suitably formatted, in Step 4, the PCD user activates an e-mail “Send” button and the e-mail is wirelessly transmitted to e-mail server 145, from where it is coupled into the Internet (not shown) for forwarding to the appropriate e-mail recipient.

The four steps that have been mentioned above will now be described in further detail in a more general manner (not limited to e-mail), using several alternative modes of operation as examples.

Delayed Transmission Mode

In this mode of operation, the PCD user enunciates material that is desired to be transcribed from speech to text. The enunciated text is stored in a suitable storage buffer in the PCD. This may be carried out, for example, by using an analog-to-digital encoder for digitizing the speaker's voice, followed by storing of the digitized data in a digital memory chip. The digitization and storage process is carried out until the PCD user has finished enunciating the entire material. Upon completion of this task, the PCD user activates a “transcribe” key on the PCD for transmitting the digitized data in the form of a data signal to cellular base station 120, after suitable formatting for wireless transmission. The transcribe key may be implemented as a hard key or a soft key, the soft key being displayed for example, in the form of an icon on a display of the PCD.

Piecemeal Transmission Mode

In this mode of operation, the PCD user enunciates material that is transmitted frequently and periodically in data form from PCD 105 to cellular base station 120. For example, the enunciated material may be transmitted as a portion of a speech signal whenever the PCD user pauses during his speaking into the PCD. Such a pause may occur at the end of a sentence for example. The speech-to-text transcription system 130 may transcribe this particular portion of the speech signal and return the corresponding text message even as the PCD user is speaking the next sentence. Consequently, the transcription process can be carried out faster in this piecemeal transmission mode than in the delayed transmission mode where the user has to completely finish speaking the entire material.

In one alternative implementation, the piecemeal transmission mode may be selectively combined with the delayed transmission mode. In such a combinational mode, a temporary buffer storage is used to store certain portions (larger than a sentence for example) of the enunciated material before intermittent transmission out of PCD 105. The buffer storage required for such an implementation may be more modest in comparison with that for a delayed transmission mode where the entire material has to be stored before transmission.

Live Transmission Mode

In this mode of operation, the PCD user activates a “transcription request” key on the PCD. The transcription request key may be implemented as a hard key or a soft key, the soft key being displayed for example, in the form of an icon on a display of the PCD. Upon activation of this key, a communication link is set up between PCD 105 and server 125 (which houses speech-to-text transcription system 130) using Internet Protocol (IP) data embedded in Transport Control Format (TCP/IP) for example. Such a communication link, referred to as a packet transmission link, is known in the art and is typically used for transporting Internet-related data packets. In an example embodiment, upon activation of the transcription request key, rather than an IP call, a telephone call, such as a circuit-switched call (e.g., a standard telephony call), is provided to the server 125 via the cellular base station 120.

The packet transmission link is used by server 105 to acknowledge to PCD 105 a readiness of the server 125 to receive IP data packets from PCD 105. The IP data packets, carrying digital data digitized from material enunciated by the user, are received in server 125 and suitably decoded before being coupled into speech-to-text transcription system 130 for transcription. The transcribed text message may be propagated to the PCD in either a delayed transmission mode or a piecemeal transmission mode, again in the form of IP data packets.

Speech-to-Text Transcription

As mentioned above, speech-to-text transcription is typically carried out in speech-to-text transcription system 130 by using a speech recognition system. The speech recognition system recognizes individual words by delegating a confidence factor for each of several alternative candidates for speech recognition, when such alternative candidates are present. For example, a spoken word “taut” may have several alternative candidates for speech recognition such as “taught,” “thought,” “tote,” and “taut.” The speech recognition system associates each of these alternative candidates with a confidence factor for recognition accuracy. In this particular example, the confidence factors for taught, thought, tote and taut may be 75%, 50%, 25%, and 10% respectively. The speech recognition system selects the candidate having the highest confidence factor and uses this candidate for transcribing the spoken word into text. Consequently, in this example, speech-to-text transcription system 130 transcribes the spoken word “taut” into the textual word “taught.”

This transcribed word, which is transmitted as part of the transcribed text from cellular base station 105 to PCD 105 in Step 2 of FIG. 2, is obviously incorrect. In one exemplary application, the PCD user observes this erroneous word on his PCD 105 and manually edits the word by deleting “taught” and replacing it with “taut”, which in this instance is carried out by typing the word “taut” on a keyboard of PCD 105. In another exemplary application, one or more of the alternative candidate words (thought, tote, and taut) are linked to the transcribed word “taught” by speech-to-text transcription system 130. In this second case, the PCD user observes the erroneous word and selects an alternative candidate word from a menu rather than manually typing in a replacement word. The menu may be displayed as a drop-down menu for example, by placing a cursor upon the incorrectly transcribed word “taught”. The alternative words may be automatically displayed when the cursor is placed upon a transcribed word, or may be displayed by activating an appropriate hardkey or softkey of PCD 105 after placing the cursor on the incorrectly transcribed word. In an example embodiment, alternative sequences of words (phrases) can be automatically displayed, and the user can chose the appropriate phrase. For example, upon selecting the word “taught”, the phrases “Rob taught”, “rope taught”, “Rob taut”, and “rope taut” can be displayed, and the user can select the appropriate phrase. In yet another example embodiment, appropriate phrases can be automatically displayed or withheld from display in accordance with confidence level. For example, the system might have a low confidence, based on general patterns of English usage, that the phrases “Rob taut” and “rope taught” are correct, and could withhold those phrases from being displayed. In further example embodiments, the system can learn from previous selections. For example, the system could learn dictionary words, dictionary phrases, contact names, phone numbers, or the like. Additionally, the text could be predicted based upon previous behavior. For example, the system may “hear” a phone number beginning with “42” followed by garbled speech. Based on a priori information in the system (e.g., learned information or seeded information), the system could deduce that that area code is 425. Accordingly, various combinations of numbers having 425 could be displayed. For example, “425-XXX-XXXX” could be displayed. Various combinations of the area and prefixes could be displayed. For example, if the only numbers stored in the system having the 425 area code have either a 707 or 606 prefix, “425-707-XXXX” and “425-606-XXXX” could be displayed. As the user selects one of the displayed numbers, additional numbers could be displayed. For example, if “425-606-XXXX” is selected, all number starting with 425-606 could be displayed.

In addition to, or in lieu of, the menu-driven correction feature described above, speech-to-text transcription system 130 may provide word correction facilities by highlighting questionably transcribed words in certain ways, for example, by underlining the questionable word by a red line, or by coloring the text of the questionable word in red. In an alternate example embodiment, the PCD can provide word correction facilities by highlighting questionably transcribed words in certain ways, for example, by underlining the questionable word by a red line, or by coloring the text of the questionable word in red.

The correction process described above may be further used to generate a customized list of vocabulary words or for creating a dictionary of customized words. Either or both the customized list and the dictionary may be stored in either or both of speech-to-text transcription system 130 and PCD 105. The customized list of vocabulary words may be used to store certain words that are unique to a particular user. For example, such words may include a person's name or a word in a foreign language. The customized dictionary may be created for example, when the PCD user indicates that a certain transcribed word must be automatically corrected in future by a replacement word provided by the PCD user.

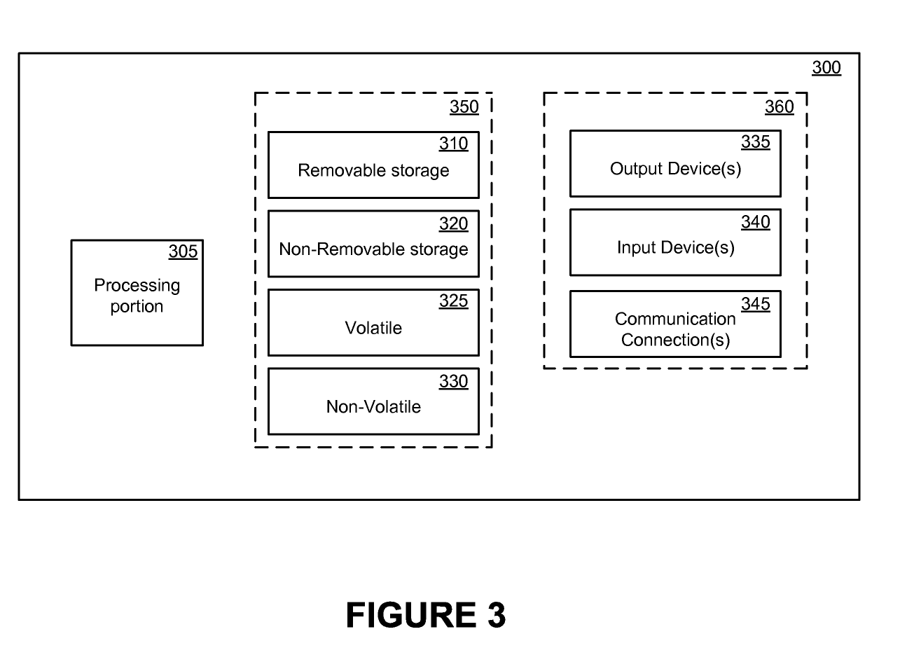

FIG. 3 is a diagram of an exemplary processor 300 for implementing speech-to-text transcription 130. The processor 300 comprises a processing portion 305, a memory portion 350, and an input/output portion 360. The processing portion 305, memory portion 350, and input/output portion 360 are coupled together (coupling not shown in FIG. 3) to allow communications therebetween. The input/output portion 360 is capable of providing and/or receiving components utilized to perform speech-to-text transcription as described above. For example, the input/output portion 360 is capable of providing communicative coupling between a cellular base station and speech-to-text transcription 130 and/or communicative coupling between a server and speech-to-text transcription 130.

The processor 300 can be implemented as a client processor, a server processor, and/or a distributed processor. In a basic configuration, the processor 300 can include at least one processing portion 305 and memory portion 350. The memory portion 350 can store any information utilized in conjunction with speech-to-text transcription. Depending upon the exact configuration and type of processor, the memory portion 350 can be volatile (such as RAM) 325, non-volatile (such as ROM, flash memory, etc.) 330, or a combination thereof. The processor 300 can have additional features/functionality. For example, the processor 300 can include additional storage (removable storage 310 and/or non-removable storage 320) including, but not limited to, magnetic or optical disks, tape, flash, smart cards or a combination thereof. Computer storage media, such as memory portion 310, 320, 325, and 330, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 300. Any such computer storage media can be part of the processor 300.

The processor 300 can also contain communications connection(s) 345 that allow the processor 300 to communicate with other devices, such as other modems, for example. Communications connection(s) 345 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. The processor 300 also can have input device(s) 340 such as keyboard, mouse, pen, voice input device, touch input device, etc. Output device(s) 335 such as a display, speakers, printer, etc. also can be included.

Though shown in FIG. 3 as one integrated block, it will be understood that processor 300 may be implemented as a distributed unit with processing portion 305 for example being implemented as multiple central processing units (CPUs). In one such implementation, a first portion of processor 300 may be located in PCD 105, a second portion may be located in speech-to-text transcription system 130, and a third portion may be located in server 125. The various portions are configured to carry out various functions associated with speech-to-text transcription for PCDs. The first portion may be used for example, to provide a drop-down menu display on PCD 105 and to provide certain soft keys such as a “transcribe” key and a “transcription request” key on the display of PCD 105. The second portion may be used for example, to perform speech recognition and for attaching alternative candidates to a transcribed word. The third portion may be used for example, to couple a modem located in server 125 to speech-to-text transcription system 130.

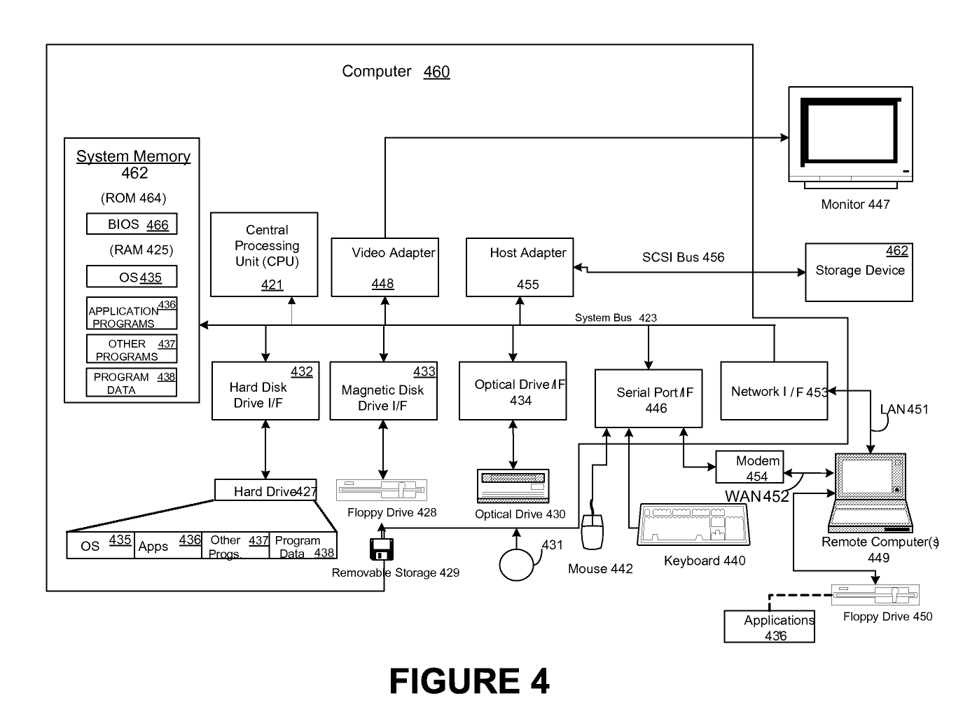

FIG. 4 and the following discussion provide a brief general description of a suitable computing environment in which speech-to-text transcription for personal communication devices can be implemented. Although not required, various aspects of speech-to-text transcription can be described in the general context of computer executable instructions, such as program modules, being executed by a computer, such as a client workstation or a server. Generally, program modules include routines, programs, objects, components, data structures and the like that perform particular tasks or implement particular abstract data types. Moreover, implementation of speech-to-text transcription for personal communication devices can be practiced with other computer system configurations, including hand held devices, multi processor systems, microprocessor based or programmable consumer electronics, network PCs, minicomputers, mainframe computers, and the like. Further, speech-to-text transcription for personal communication devices also can be practiced in distributed computing environments where tasks are performed by remote processing devices that are linked through a communications network. In a distributed computing environment, program modules can be located in both local and remote memory storage devices.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 421, the memory (both ROM 464 and RAM 425), the basic input/output system (BIOS) 466, and various input/output (I/O) devices such as a keyboard 440, a mouse 442, a monitor 447, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users). In an example embodiment, application programs perform the functions associated with speech-to-text transcription for personal communication devices as described above.

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. A purpose of a hardware/software interface system is to provide an environment in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

As shown in FIG. 4, an exemplary general purpose computing system includes a conventional computing device 460 or the like, including a central processing unit 421, a system memory 462, and a system bus 423 that couples various system components including the system memory to the processing unit 421. The system bus 423 may be any of several types of bus structures including a memory bus or memory controller, a peripheral bus, and a local bus using any of a variety of bus architectures. The system memory includes read only memory (ROM) 464 and random access memory (RAM) 425. A basic input/output system 466 (BIOS), containing basic routines that help to transfer information between elements within the computing device 460, such as during start up, is stored in ROM 464. The computing device 460 may further include a hard disk drive 427 for reading from and writing to a hard disk (hard disk not shown), a magnetic disk drive 428 (e.g., floppy drive) for reading from or writing to a removable magnetic disk 429 (e.g., floppy disk, removal storage), and an optical disk drive 430 for reading from or writing to a removable optical disk 431 such as a CD ROM or other optical media. The hard disk drive 427, magnetic disk drive 428, and optical disk drive 430 are connected to the system bus 423 by a hard disk drive interface 432, a magnetic disk drive interface 433, and an optical drive interface 434, respectively. The drives and their associated computer readable media provide non volatile storage of computer readable instructions, data structures, program modules and other data for the computing device 460. Although the exemplary environment described herein employs a hard disk, a removable magnetic disk 429, and a removable optical disk 431, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like may also be used in the exemplary operating environment. Likewise, the exemplary environment may also include many types of monitoring devices such as heat sensors and security or fire alarm systems, and other sources of information.

A number of program modules can be stored on the hard disk 427, magnetic disk 429, optical disk 431, ROM 464, or RAM 425, including an operating system 435, one or more application programs 436, other program modules 437, and program data 438. A user may enter commands and information into the computing device 460 through input devices such as a keyboard 440 and pointing device 442 (e.g., mouse). Other input devices (not shown) may include a microphone, joystick, game pad, satellite disk, scanner, or the like. These and other input devices are often connected to the processing unit 421 through a serial port interface 446 that is coupled to the system bus, but may be connected by other interfaces, such as a parallel port, game port, or universal serial bus (USB). A monitor 447 or other type of display device is also connected to the system bus 423 via an interface, such as a video adapter 448. In addition to the monitor 447, computing devices typically include other peripheral output devices (not shown), such as speakers and printers. The exemplary environment of FIG. 4 also includes a host adapter 455, Small Computer System Interface (SCSI) bus 456, and an external storage device 462 connected to the SCSI bus 456.

The computing device 460 may operate in a networked environment using logical connections to one or more remote computers, such as a remote computer 449. The remote computer 449 may be another computing device (e.g., personal computer), a server, a router, a network PC, a peer device, or other common network node, and typically includes many or all of the elements described above relative to the computing device 460, although only a memory storage device 450 (floppy drive) has been illustrated in FIG. 4. The logical connections depicted in FIG. 4 include a local area network (LAN) 451 and a wide area network (WAN) 452. Such networking environments are commonplace in offices, enterprise wide computer networks, intranets and the Internet.

When used in a LAN networking environment, the computing device 460 is connected to the LAN 451 through a network interface or adapter 453. When used in a WAN networking environment, the computing device 460 can include a modem 454 or other means for establishing communications over the wide area network 452, such as the Internet. The modem 454, which may be internal or external, is connected to the system bus 423 via the serial port interface 446. In a networked environment, program modules depicted relative to the computing device 460, or portions thereof, may be stored in the remote memory storage device. It will be appreciated that the network connections shown are exemplary and other means of establishing a communications link between the computers may be used.

While it is envisioned that numerous embodiments of speech-to-text transcription for personal communication devices are particularly well-suited for computerized systems, nothing in this document is intended to limit speech-to-text transcription for personal communication devices to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

The various techniques described herein can be implemented in connection with hardware or software or, where appropriate, with a combination of both. Thus, the methods and apparatuses for speech-to-text transcription for personal communication devices, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for implementing speech-to-text transcription for personal communication devices.

The program(s) can be implemented in assembly or machine language, if desired. In any case, the language can be a compiled or interpreted language, and combined with hardware implementations. The methods and apparatuses for implementing speech-to-text transcription for personal communication devices also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like. When implemented on a general-purpose processor, the program code combines with the processor to provide a unique apparatus that operates to invoke the functionality of speech-to-text transcription for personal communication devices. Additionally, any storage techniques used in connection with speech-to-text transcription for personal communication devices can invariably be a combination of hardware and software.

While speech-to-text transcription for personal communication devices has been described in connection with the example embodiments of the various figures, it is to be understood that other similar embodiments can be used or modifications and additions can be made to the described embodiments for performing the same functions of speech-to-text transcription for personal communication devices without deviating therefrom. Therefore, speech-to-text transcription for personal communication devices as described herein should not be limited to any single embodiment, but rather should be construed in breadth and scope in accordance with the appended claims.

What is claimed:

1. A method for generating text, comprising:
generating a speech signal by speaking into a personal communication device;
transmitting the generated speech signal; and
receiving in response to the transmitting, a text message in the personal communication device, the text message having been generated by transcribing the speech signal using a speech-to-text transcription system located external to the personal communication device.

2. The method of claim 1, wherein the speech signal is generated as a result of speaking at least one of an e-mail address, a subject-line text, or at least a portion of a body of an e-mail message.

3. The method of claim 1, wherein:
generating the speech signal comprises storing at least a portion of the speech signal in the personal communication device; and
transmitting the generated speech signal comprises depressing a button on the personal communication device for transmitting the stored speech signal in a delayed transmission mode.

4. The method of claim 1, wherein:
generating the speech signal comprises depressing a button on the personal communication device for requesting transcription; and
transmitting the generated speech signal comprises:
receiving an acknowledgement at the personal communication device; and
transmitting the speech signal in a live transmission mode.

5. The method of claim 1, wherein transmitting the generated speech signal comprises transmitting the speech signal in a piecemeal transmission mode.

6. The method of claim 1, wherein transmitting the generated speech signal comprises at least one of:
transmitting the speech signal in a digital format; or
transmitting the speech signal as a telephony call.

7. The method of claim 6, wherein the digital format comprises an Internet Protocol (IP) digital format.

8. The method of claim 1, further comprising:
editing the text message; and
transmitting the text message in an e-mail format.

9. The method of claim 8, wherein editing the text message comprises:
replacing at least one word in the text message with an alternative word, the replacement being carried out by one of manually typing in the alternative word or selecting the alternative word from a menu of alternative words provided by the speech-to-text transcription system.

10. A method for generating text, comprising:
receiving in a first server, a speech signal generated by a personal communication device;
transcribing the received speech signal into a text message by using a speech-to-text transcription system located in a second server; and
transmitting the generated text message to the personal communication device.

11. The method of claim 10, wherein the first server is the same as the second server.

12. The method of claim 10, further comprising:
receiving in the first server, a transcription request from the personal communication device; and
setting up in response thereto, a data packet communication link between the first server and the personal communication device for transporting the speech signal from the personal communication device to the first server in the form of digital data packets.

13. The method of claim 10, wherein using the speech-to-text transcription system comprises:
generating a list of alternative candidates for speech recognition of a spoken word, wherein each alternative candidate has an associated confidence factor for recognition accuracy.

14. The method of claim 13, further comprising:
transmitting from the first server to the personal communication device, the list of alternative candidates in a drop-down menu format linked to a transcribed word.

15. A computer-readable storage medium having stored thereon computer-readable instructions for performing the steps of:
communicatively coupling a server to a personal communication device;
receiving in the server, a speech signal generated in the personal communication device;
transcribing the received speech signal into a text message by using a speech-to-text transcription system located in the server; and
transmitting the generated text message to the personal communication device.

16. The computer-readable medium of claim 15, wherein using the speech-to-text transcription system comprises:
generating a list of alternative candidates for speech recognition of a spoken word, wherein each alternative candidate has an associated confidence factor for recognition accuracy;
creating a transcribed word from the spoken word by using one of the alternative candidates that has the highest confidence factor; and
appending the list of alternative candidates to the transcribed word.

17. The computer-readable medium of claim 16, wherein transmitting the generated text message to the personal communication device comprises transmitting to the personal communication device, the transcribed word together with the appended list of alternative candidates.

18. The computer-readable medium of claim 17, wherein the list of alternative candidates is appended to the transcribed word in a drop-down menu format.

19. The computer-readable medium of claim 15, further comprising generating a database containing at least one of a preferred vocabulary or a set of speech recognition training words.

20. The computer-readable medium of claim 19, further comprising computer-readable instructions for performing the steps of:
editing the generated text message in the personal communication device; and
transmitting from the personal communication device, the text message in an e-mail format.
